(19) United States
(12) Patent Application Publication
(10) Pub. No.: US 2011/0153504 A1
(43) Pub. Date: Jun. 23, 2011

(54) POSTCARD GREETINGS FOR DIRECT MARKETING

(75) Inventors: John W. Rojas, Norwalk, CT (US); Theresa Biasi, Shelton, CT (US); Anuja Ketan, Oxford, CT (US)

(73) Assignee: Pitney Bowes Inc., Stamford, CT (US)

(21) Appl. No.: 12/641,574

(22) Filed: Dec. 18, 2009

(51) Int. Cl. G06Q 30/00; H04L 9/00; G06Q 10/00; G06Q 99/00; G09C 1/00; B42D 15/02

(52) U.S. Cl. 705/75; 705/14.25; 705/14.38; 705/14.45; 705/14.66; 705/319; 283/17; 283/56; 283/116

(57) ABSTRACT

A method for customizing direct marketing campaigns, by utilizing relationships within a computer social network and information that is known about the social network members to find the best opportunity to provide an offer for goods and services to potential customers; providing offers for the goods and the services via the computer based upon receiving recommendations from acquaintances of potential customers via the social networks; and sending offers to the potential customers via the computer on behalf of their acquaintance.

### FIELD OF THE INVENTION

The invention relates to direct marketing campaign systems and methods and more particularly to systems and methods for customizing direct marketing utilizing mail pieces.

### BACKGROUND OF THE INVENTION

Many companies throughout the United States use the delivery services of the United States Postal Service (USPS) to deliver direct mail marketing materials to their customers and potential customers. A company might employ a blanket direct mail campaign if they wish to reach each household in a given area. However, a targeted direct mailing campaign may be more cost effective. Accordingly, many companies utilize information processing systems to determine a targeted mailing list of a subset of households in a given area in order to optimize the cost of the mailing and expected response rate for a direct mail campaign.

Companies may maintain customer profile data for their customers and may have a direct marketing mailing list comprising the current and/or past customers of the company. Additionally, such companies may advertise using targeted direct mail campaigns and might then rent access to a targeted list of potential customers from a mailing list broker using selection criteria that is typically based upon block group level U.S. Census Bureau data. Such advertisers often do not receive a list of the potential customers selected, but the direct mail company addresses and finishes the direct mail pieces and inducts them with the USPS. In certain campaigns, advertisers may have access to individual profile based demographic and or psychographic targeted marketing data. Such individual profile data may be found in the advertiser's customer files or in certain circumstances may also be available from third parties subject to appropriate privacy regulations. However, traditional direct mail campaign processes do not provide for creating a targeted marketing direct mailing list by adding to a customer mailing list an efficient number of additional names selected using targeted marketing techniques to optimize postage expense.

Direct mail effectiveness depends on several factors including targeting the appropriate potential customers, providing an offer of sufficient value and using attractive design and content in the direct mail piece. Direct mail creation information processing systems now also provide at least a limited ability for providing personalized direct mail pieces using variable data printing. For example, the name of the targeted potential customer may be used in the advertising section of the direct mail piece to create a direct mail piece tailored for the individual potential customer.

In traditional direct marketing campaigns mail pieces are prepared and delivered in bulk. Advertisers or companies marketeering goods and services pay for the bulk mailing which targets a list of potential customers. The foregoing approach does not take into account when the potential customers are likely to purchase goods and services.

Accordingly, there are several disadvantages of currently available systems and methods for customizing direct mail pieces.

### SUMMARY OF THE INVENTION

This present invention overcomes the disadvantages of the prior art by utilizing social networks to promote goods and services and using relevant data for direct marketing campaigns. The invention takes advantage of social networks by enabling a company to provide offers for goods and services by receiving recommendations from acquaintances of potential customers and sending offers to the potential customers on behalf of their acquaintance. Furthermore, the invention utilizes the relationships within a social network and information that is known about its members to find the best opportunity to provide the offer. For instance, if an acquaintance knows that a potential customer is going on a skiing vacation, the customer may want to receive offers regarding skiing equipment. Thus, the acquaintance may send a greeting card through the system of this invention to the potential customer that is sponsored by a ski equipment store.

An advantage of the foregoing is that the ski equipment store sends a direct marketing offer to potential customers through the system of this invention when there is a higher probability of a sale, i.e., when the system receives a recommendation from an acquaintance about a potential customer for a particular offer. At this point in time the system would prepare and send a mail piece containing the ski stores offer to the potential customer as well as charge the ski store for the preparation and delivery of the mail piece.

An additional advantage of this invention is that it enables local companies to reach customers that are not in the companies' geographic area and outside their traditional marketing campaign. For example, the potential customer lives in Connecticut and is traveling to Colorado for a ski vacation. The local ski equipment company in Colorado that is a member of the system of this invention may be given an opportunity to send direct mailing offers to this customer.

### BRIEF DESCRIPTION OF THE DRAWINGS

FIG. 1A is a drawing of the front of a customized post card;

FIG. 1B is a drawing of the back of a customized post card;

FIG. 1C is a drawing of a customized mail piece;

FIG. 2 is a block diagram of this invention;

FIG. 3A is a flow chart of the register a new member program contained in computer 51;

FIG. 3B is a flow chart of the send a greeting program contained in computer 51;

FIG. 3C is a flow chart of the greeting wizard program contained in computer 51; FIG. 3D is a flow chart of the offer matching program contained in computer 51;

FIG. 4 is a flow chart that takes place when an offer is used, which is part of the Vendor point of sale computer 58 and Computer 51;

FIG. 5 a flow chart of the program that registers a new vendor in the application, which is part of Vendor Management System, Computer 56; and

FIG. 6 depicts the program to scan member profiles, which runs inside Computer 51.

### DETAILED DESCRIPTION OF THE PREFERRED EMBODIMENT

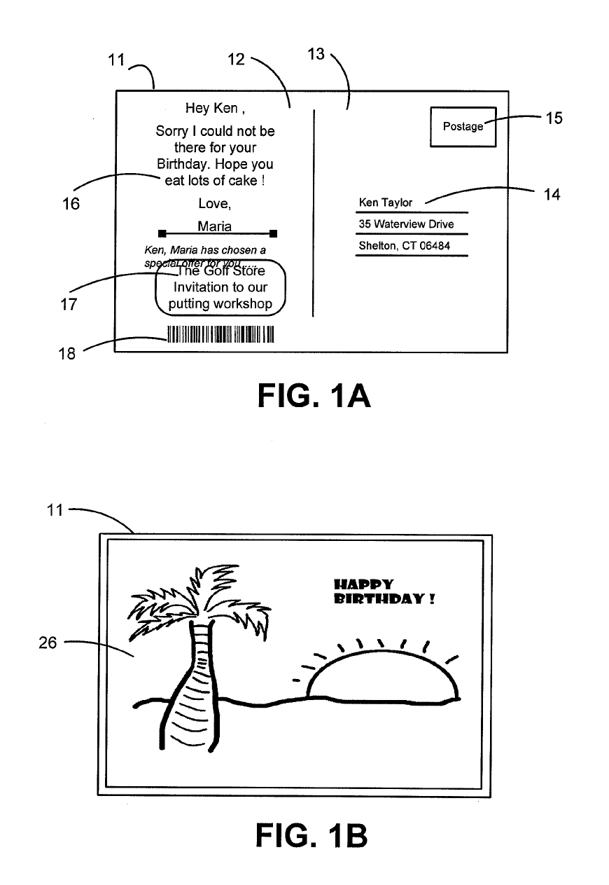

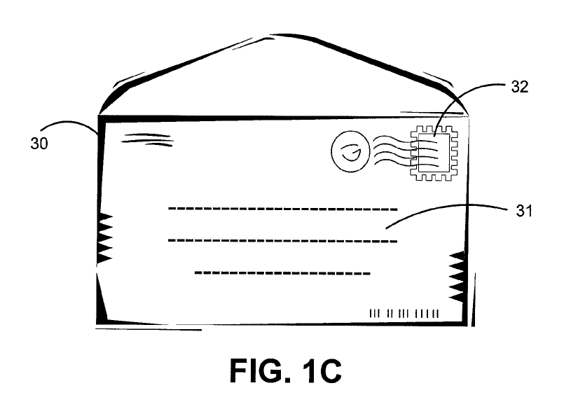

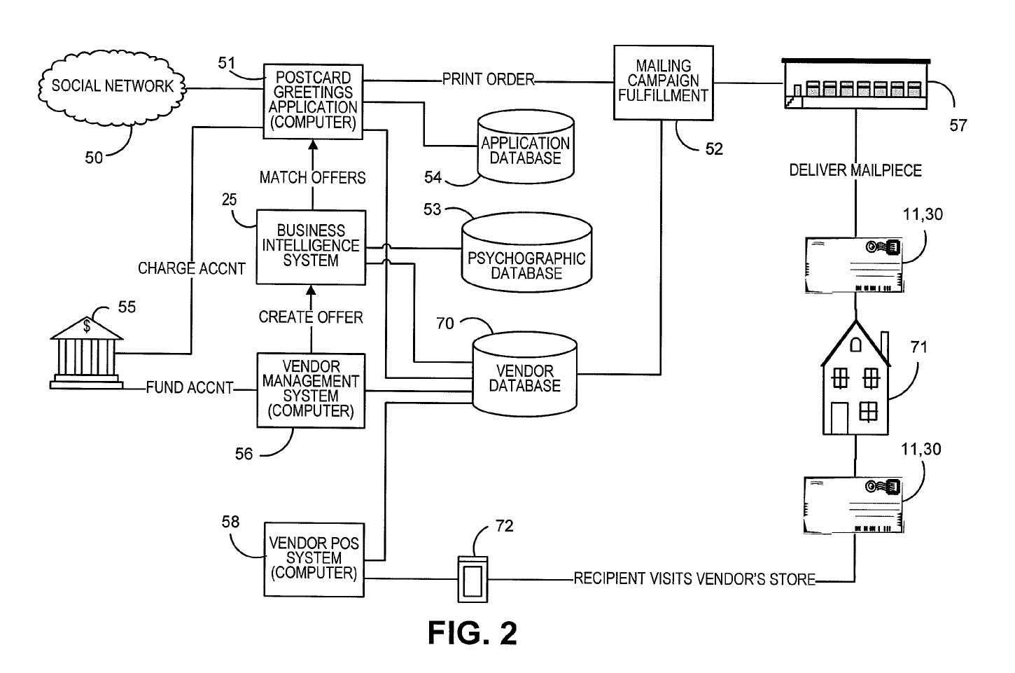

Referring now to the drawings in detail, and more particularly to FIG. 1A, the reference character 11 represents the front of a post card having a left portion 12 and a right portion 13. Right portion 13 of post card 11 has a subscriber or recipient address field 14, an indication of postal payment 15 and a unique number that is contained in bar code 18. Left portion 12 of post card 11 has a greeting from a friend or acquaintance 16, and an offer 17 for the purchase of goods or services.

FIG. 1B is a drawing of the back of post card 11 containing greetings 26.

FIG. 1C is a drawing of a customized mail piece 30. The front of mail piece 30 in the form of an envelope contains recipient address field 31 and an indication of postal payment 32. The information contained in left portion 12 of post card 11 and the greetings 26 indicated on the back of post card 25 may be combined to form a booklet, card, sheet of paper or multiple sheets of paper and then inserted into customized mail piece or envelope 30.

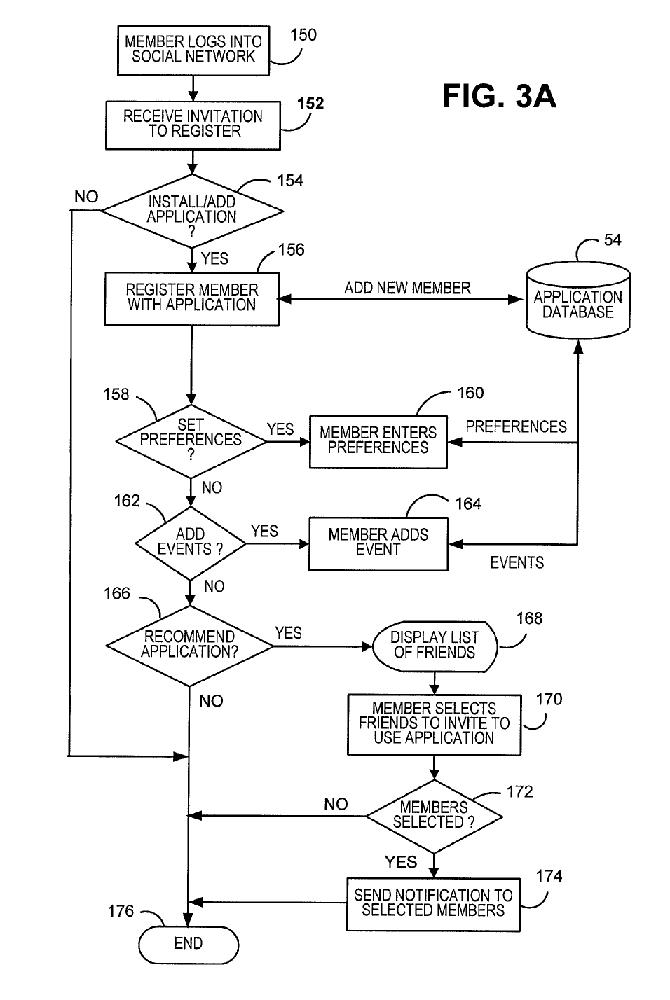

FIG. 2 is a block diagram of this invention. A social network 50 like Facebook, Twitter, etc. is coupled to postal greetings application computer 51. Social Network 50 contains member profiles (including privacy preferences) and member connections. Computer 51 is coupled to mailing campaign fulfillment 52, business intelligence system 25, application database 54 and vendor database 70. Psychographic Database 53 contains preferences and profiles of potential customers for different types of goods and/or services based upon where the goods and/or services are located. Data base 54 contains Member (Recipient/Sender) data; preferences; mined preferences; extended demographics (beyond serial number profile); greeting opportunities and application permissions. Database 70 contains: offers; vendor or business data; account data; payment preferences; campaigns; campaign results and tracking information. Psychographic database 53 is coupled to business intelligence system 25 and system 25 is coupled to vendor management computer 56 and vendor data base 70.

A financial institution 55 like a bank or Pay Pal is coupled to postal application computer 51, vendor point of sale system 58 and vendor management computer 56. Computer 56 is coupled to business intelligence system 25, database 70 and database 70 is coupled to mailing campaign fulfillment 52. Mailing campaign fulfillment 52 will produce post card 11 with an appropriate indication for the payment of postage as well as the material being inserted into envelope 30 and envelope 30. Mailing campaign fulfillment 52 will deposit post card 11 and/or envelope 30 with carrier 57. Carrier 57 may be the United States Postal Service, a courier, or private delivery service, i.e., Federal Express®, United Parcel Service®, DHL®, Emory®, Airborne,®, etc. Post card 11 and/or envelope 30 are delivered to a recipient 71. Recipient 71 will bring post card 11 and/or envelope 30 to vendor/store bar code scanner 72. Bar code scanner 72 is coupled to Vendor point of sale computer 58. Computer 58 is coupled to vendor database 70. Post card 11 and/or envelope 30 will be registered by computer 58 and reported to vendor data base 70 for further processing.

For the sake of clarification the subscriber is the sender of postcard 11 and/or envelope 30 and the subscriber's friend is the recipient of postcard 11 and/or envelope 30. Someone on social network 50 subscribes to the services of postal greetings application computer 51. Computer 51 will notify one of the subscribers to computer 51 that there is an opportunity to send a greeting to the subscriber's friends. If the subscriber desires to accept the notification, the postal greetings application computer 51 will prepare the greeting 16, 26 (FIGS. 1A and 1B) selected by the subscriber. The subscriber will also select the offer 17 of the vendor that is sponsoring the greeting.

The subscriber submits the greeting for delivery to the friend via computer 51. Then the postal greetings application computer 51 sends the greetings in electronic format to mailing campaign fulfillment 52 where post card 11 and/or envelope 30 is printed and addressed using standard mail finishing, sorting, inserting and metering equipment manufactured by Pitney Bowes, Inc. of One Elmcroft Drive, Stamford, Conn. Then post card 11 and/or envelope 30 is deposited with carrier 57 for delivery to the subscriber/recipient. The subscriber/recipient will subsequently, review the greetings and offer appearing in post card 11 and/or envelope 30.

Since the offer was received from the subscriber and the offer has been specially chosen by the subscriber the friend is more likely to act on the offer. The reason for the foregoing may be that the greeting or offer is for the friend's birthday, a holiday, anniversary, birth of a child, graduation or other special event of the subscriber, i.e., planned vacation or sporting event, etc. When the friend decides to act on the offer, then the friend will bring the greeting and the offer to the sponsoring vendor or store. Using bar code scanner 72 and the vendor point of sale system 58 an employee of the sponsoring vendor or store will scan the offer and bar code 18 containing a unique encrypted number and determine the offers authenticity. Upon verification of bar code 18 utilizing database 70 the sponsoring vendor or store may honor the offer and complete the sale of the selected goods and/or services. When the offer is validated a notification is sent to vendor management computer 56 via vendor point of sale system 58 and data base 70. Vendor management computer 56 tracks all outstanding offers. This allows the sponsoring vendor or store to track the success rate or response rate of mailing campaigns containing specific offers.

Subscriber's can pay additional money to give the friend a better offer by depositing money with financial institution 55 or loaning money from financial institution 55 or paying later. The sponsoring vendor or store may go to financial institution 55 to receive a loan to fund a mailing campaign.

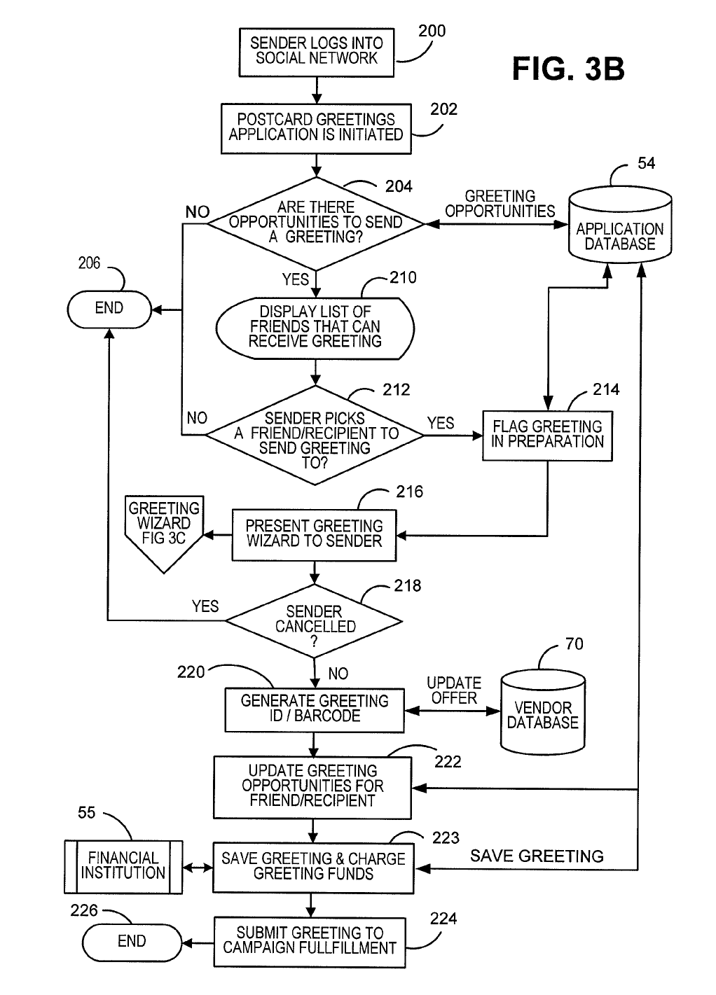

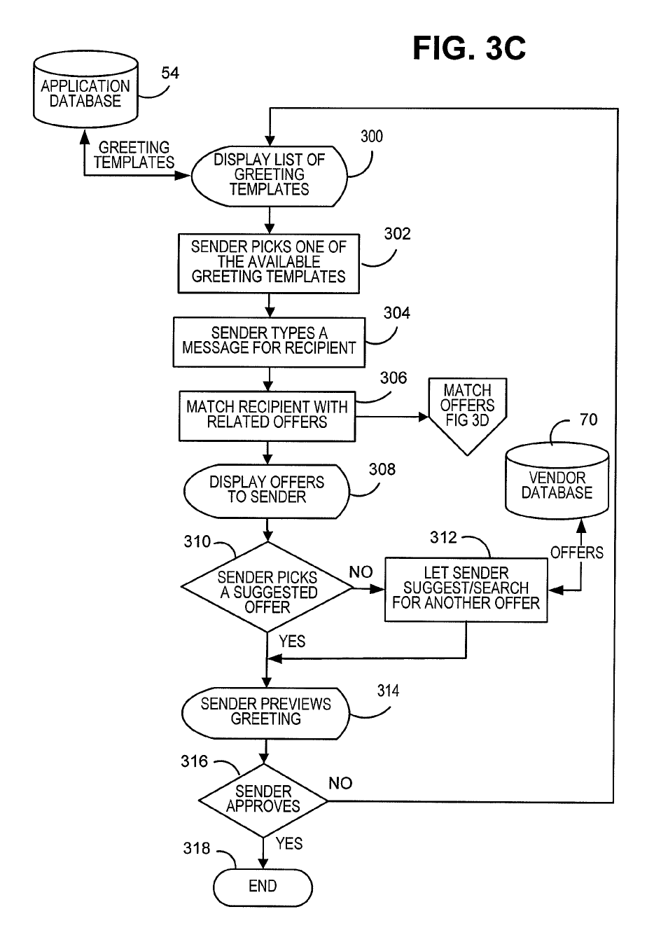

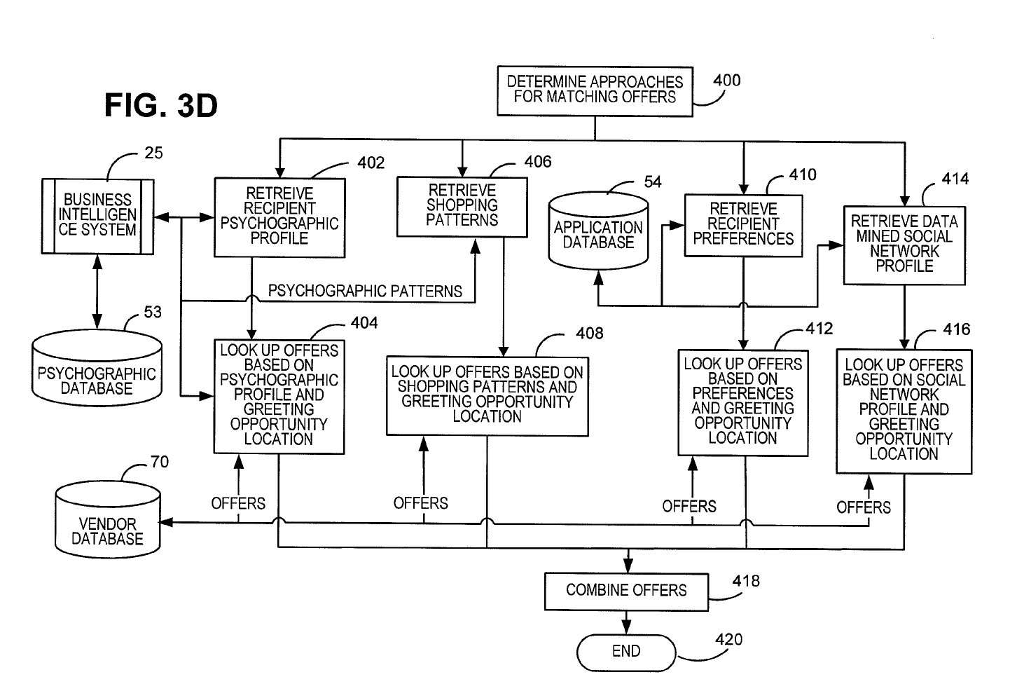

FIG. 3A is a flow chart of the register a new member program contained in computer 51. The program begins in block 150, when the member logs into the social network, and follows with step 152, where the sender receives an invitation to install or add the application into his/her social network profile. If the member decides not to install the application, the program continues to block 176, where the program ends. If the member decides to accept the invitation the program goes to block 156 where the member is added to the application database 54, using default preferences and no events. The program continues to block 158, where the member is given the option of setting preferences and if the member decides to set preferences, the program continues in block 160, where the member specifies preferences. The program then continues in block 162, where the member is given a choice for adding events (greeting opportunities, i.e., it is my birthday, anniversary, graduation, I purchased a new house, I purchased a new car, etc.), and if the member decides to add new events, the program continues in block 164. In block 164, for each event added by the member, the member specifies the name of the event, date, location, and a description of the event (text, keywords, tags, etc.)

Then in block 166, the member is asked if he/she wants to recommend the application to friends in his/her social network. If the member wants to recommend the application, the process follows with step 168, where a list of friends on the members social network is displayed. Then in block 170, the member selects the friends that will receive the recommendation. Then in block 172, if at least one member was selected, the program goes to step 174, where the notification is sent to the selected members. If the member decides not to recommend the application, or if no friends are selected by the member, the program continues to step 176, where the program ends.

FIG. 3B is a flow chart of the send a greeting program contained in computer 51. The program begins in block 200 where the sender logs on to social network 50 (FIG. 2). Then in block 202 the post card greeting application is initiated. Next the program goes to decision block 204. Block 204 determines whether or not there are opportunities to send a greeting. If block 204 determines that there are no opportunities to send a greeting the program ends in block 206. If block 204 determines that there are opportunities to send a greeting the program obtains greeting opportunity application data from application data base 54. Data base 54 contains a limitation on the number of greetings the recipient may receive. Then the program goes to block 210. Block 210 displays a list of friends that can receive greetings. Then the program goes to decision block 212. Decision block 212 determines whether or not the sender picks a friend/recipient to send a greeting to. If block 212 determines that the sender did not pick a friend/recipient to send a greeting to the program ends in block 206. If block 212 determines that the sender picked a friend/recipient to send a greeting to the program goes to block 214. Block 214 flags the greeting in preparation and receives information from block 208.

At this point the program goes to block 216 to present the greeting wizard to the sender so that the sender may create a greeting. The greeting wizard program is described in the description of FIG. 3C. Then the program goes to decision block 218. Decision block 218 determines whether or not the sender cancelled the greeting. If block 218 determines that the sender cancelled the greeting the program ends in block 206. If block 218 determines that the sender did not cancel the greeting the program goes to block 220. In step 220, a unique barcode is generated for the greeting. In addition, the greeting is added to the list of greetings associated with the offer used in this greeting that is stored in vendor database 70. Now the program goes to block 222 to update greeting opportunities or rules for the friend/recipient so that a recipient will not receive an excessive number of greetings. Some of the greeting opportunities are: how many greetings can the recipient receive, free offers are limited but dollar offers are not; how do you manage free offers, i.e., per recipient ip address, per store, per region, etc. Then in step 223 the greeting is saved in applications data base 54 and vendor's account in financial institution 55 (FIG. 2) is charged for the greeting funds. Now the program goes to block 223 where bar code 18 is generated for the greeting. The identification, i.e., unique number contained in bar code 18 is tied to the selected offer that is stored in vendor database 70 and the new greeting is stored with its corresponding unique number in application database 54. Then the program goes to block 224 to submit the greeting to mailing campaign fulfillment 52 (FIG. 2). Next the program ends in block 226.

FIG. 3C is a flow chart of the greeting wizard program contained in computer 51. The program begins in block 300 where the available greeting templates are retrieved from Application Data 54 and displayed to the sender. The process follows with block 302, where the sender picks one of the available greeting templates. The greeting template will specify the layout and the design of the image that will be displayed in the greeting. Then in block 304, the sender types a message for the recipient. The process then follows with block 306, Match recipient with related offers, where the offers that are most appropriate or best suited for recipient are retrieved. See FIG. 3D Match Offers for details. Then in block 308, Display offers to Sender, the list of offers that were matched for the recipient are displayed to the sender and in block 310, the sender picks one of the suggested offers. Given the sender has personal knowledge of the recipient, his/her tastes, likes/dislikes, it is possible that the sender may be able to provide an even better recommendation than what was matched. In that case, if the sender does not choose one of the recommended offers, the process continues in block 312, Let sender suggest/search for another offer, where the sender is allowed to type in a keyword to search, or to browse through the offers stored in Vendor database 70.

The process continues in block 314, Sender previews greeting, where a preview of the front and back of the greeting (FIG. 1A and FIG. 1B) is presented to the sender for approval. The preview will show the greeting to the sender, as it would be seen by the recipient, including the design chosen by the sender, the sender's message, and the offer by the vendor that is sponsoring the greeting. Then in block 316, Sender approves greeting, the sender can decide to make changes before sending the greeting. If the sender decides to edit the greeting, then the process follows with block 300 where the sender will be given the option to make changes to any part of the greeting: the template/design, the message, or the offer that was chosen. If the sender approves the greeting, the process continues to block 318, where control returns to the Send a Greeting flow chart.

FIG. 3D is a flow chart of the Match Offers program contained in computer 51. The program begins in block 400 where the approach for matching offers is determined. This can be based on preferences stated by the vendor or recipient, or by choosing the approach that has previously given the best response rate for the vendor, type of product, or type of recipient. For example, psychographic matching may work better for 30 year old males living in California, but member preferences may work better for 20 year olds. Also dinner offers perform better if they are selected only by the sender. If psychographic matching is used, the process continues in block 402 where the recipient's psychographic profile is retrieved from Business Intelligence System 25, which in turn receives data from psychographic database 53. The process then continues with block 404, where available offers are retrieved from Vendor database 70. Offers are matched based on the location of the recipient, or the recipient's event, characteristics of the offer, the vendor, and characteristics of the recipient. If the matching approach allows for using shopping patterns, the process also continues in block 406, where shopping patterns for people similar to the recipient are retrieved from Vendor database 70, using the recipient's psychographic profile that is retrieved from Business Intelligence System 25. Then in Block 408, offers from Vendor database 70, are matched based on the location of the recipient, or the recipient's event, and similarities to offers in the shopping patterns retrieved in block 406. For example, people with similar psychographic data backgrounds purchase golf clubs, then offers for golf clubs or related products would be matched.

If the matching approach allows for using recipient based preferences, the process continues in block 410, where the recipient's matching preferences are retrieved from Application database 54. And then in block 412, where offers are retrieved and matched from Vendor database 70, using characteristics about the offer, location of the recipient, or the recipient's event, and recipient matching preferences. For example, if the recipient specifies a preference for sporting goods, then offers for sporting goods would be retrieved. If the matching approach allows for using data mining this may also require the recipient's permission to allow mining of their profile on the social network. The process also continues with block 414, where data mined from the recipient's profile on the social network is retrieved from Application database 54. The data that is mined will provide keywords indicating recipient's tastes, preferred activities, foods, places, etc. Then in block 416, offers are retrieved from Vendor database 54, and matched using characteristics about the offer, location of the recipient, or the recipient's event, and keywords mined from the recipient's social network profile. Once all matching approaches are performed, the process continues in block 418, combine offers, where a list of all the offers that were matches is prepared. The offers that are duplicated (i.e. returned by more than one approach) are placed at the top of the list. The process finished with block 420, where the list of matched offers is returned.

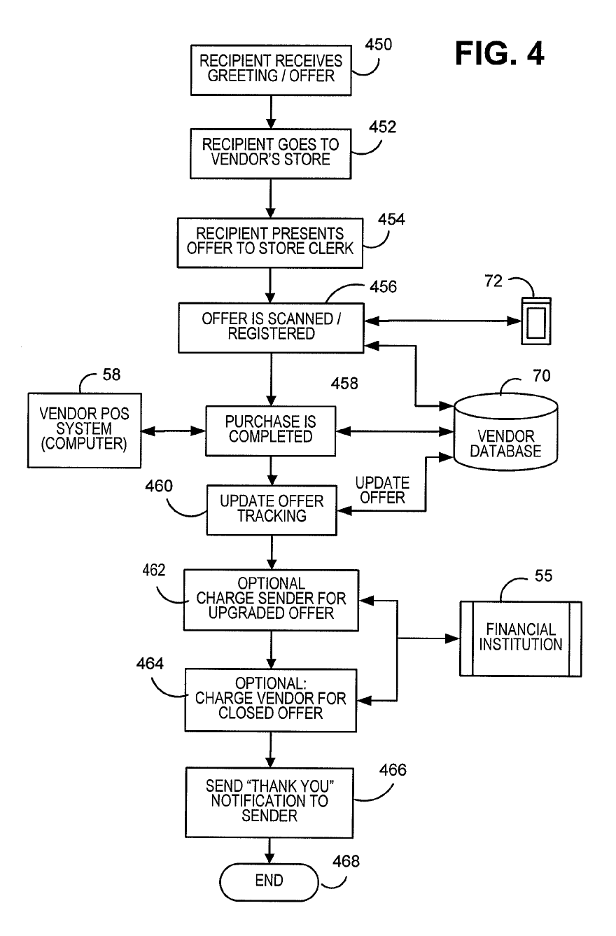

FIG. 4 is a flow chart that takes place when an offer is used, which is part of the Vendor point of sale computer 58 and Computer 51 (FIG. 2). The process begins in block 450 when the recipient received the greeting/offer. The fact that the greeting comes from one of the recipient's friends, will make the offer that is attached to the greeting more compelling to the recipient. The process continues in block 452, when the recipient visits the vendor's store. The recipient will have an opportunity to take advantage of the offer that was attached to the greeting, as well as purchase additional products/services. Then, the process continues in block 454, when the recipient has completed his/her purchases, he/she presents the offer to the store clerk, and then continues in block 456, when the offer is scanned by Barcode Scanner 72. The offer is also updated in the Vendor Database 70, to indicate that one of the associated barcodes for the offer was scanned. This allows for the vendor to track offers that were scanned, even if the purchase was not completed. The process then continues in block 458, where the purchase is completed through the Vendor point of sale computer 58.

Then in step 460, the offer is updated in vendor database 70, to indicate that a purchase was completed. In addition the date/time of the purchase, recipient and sender characteristics, and any other merchandise or services that were purchased along with dollar amounts for what was purchased, and any other relevant information associated with the sale. The process now continues from computer 51, in block 462, where the sender is charged for upgrading the offer, if the sender paid to upgrade the offer. Then in block 464, the vendor is charged for closing the sale, in the event the vendor agreed to pay an additional fee for offers that are converted to sales. Then in block 466, a “Thank You” notification is sent to the sender on behalf of the recipient. The process then ends in block 468.

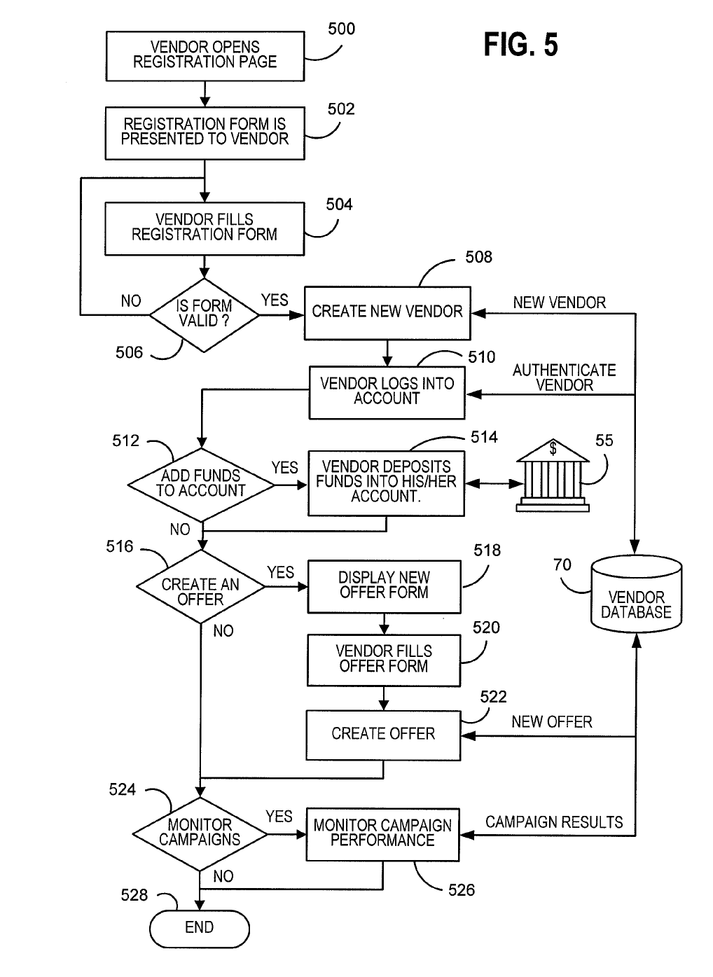

FIG. 5 a flow chart of the program that registers a new vendor in the application, which is part of Vendor Management System, Computer 56. The program begins in block 500 when the Vendor opens the registration page, which is followed by block 502, where a registration form is presented to the vendor. Then the vendor fills the registration form in block 504 by providing the Vendor name, description of the business, location, keywords about the vendor's business, psychographic information about the businesses customers or potential customers, to help with matching with offers, authentication credentials for the vendor's account, and contact information. Then in block 506, the form is validated and if invalid, the process will continue with block 504, so that the vendor can update incorrect information in the form. If the form is valid, then in block 508, the vendor is created and added to the Vendor Database 70. Then in block 510, the vendor is logged into the account, so that registration can proceed. It is also possible, under different embodiments, to send a confirmation email, to verify the vendor's contact information before allowing access to the new account.

The program follows with block 512, where the vendor can choose to fund his account. Then in block 514, the vendor adds funds to his account through Financial Institution 55. The program follows with block 516, where the vendor can choose to create an offer, which will be promoted on a social network. To create the new offer, the process continues in block 518, where a new offer form is displayed to the vendor and in block 520, where the vendor fills out the form by specifying the offer name, description, and location of the offer—if different from the vendor's location, graphic images, and keywords, to describe the offer. The vendor also provides general psychographic matching criteria for likely consumers of the offer as well as the social networks where the offer should be marketed, such as Facebook, Myspace, HiS, etc. Then in block 522, the new offer is created in Vendor Database 70. The process continues in block 524, Monitor campaigns, where the vendor can choose to view the results/status of campaigns, where offers are being actively marketed. In block 526, Monitor campaign performance, the vendor can view how each offer is performing, for example, see how many times the offer has been matched, printed on a greeting, and actually converted to a sale. The vendor will also be able to see which matching approach provided best results, whether it was though the psychographic matching approach, or sender suggestions, etc. Finally, in block 528 the process ends.

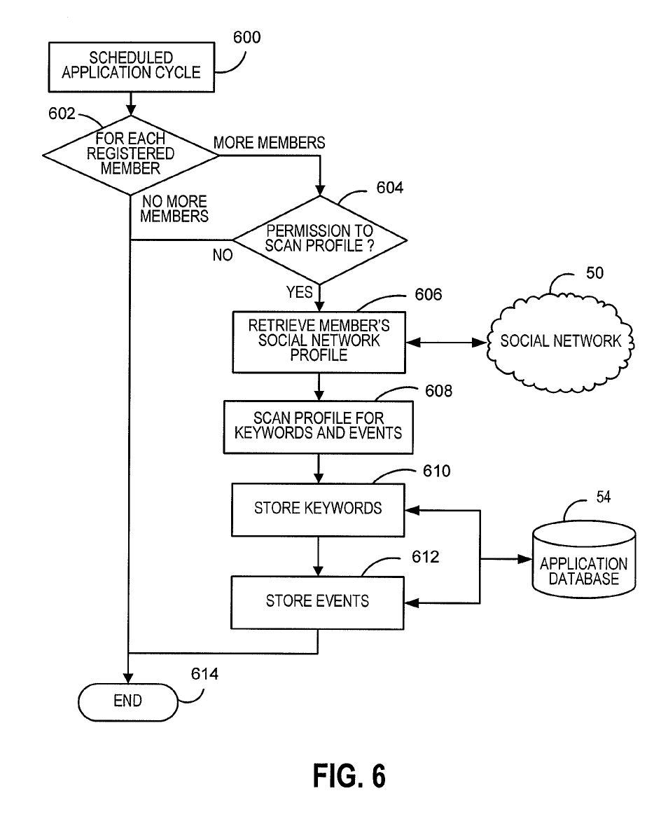

FIG. 6 depicts the program to scan member profiles, which runs inside Computer 51. This program executes for each social network where the application has been deployed to. The program begins in block 600, at a scheduled application cycle. For example, at 30 minute intervals, or hours, etc intervals. Alternatively, the scan can occur after a change to a member's social network profile, in the event the social network provided such a notification to the application. The program continues in block 602, where a scan is performed for each member that has registered to use the application, until there are no more members remaining. When no more members remain, the process will end in block 614. In block 604, a check is made if the member has given permission to have their profile scanned. If permission is not granted, the program ends in block 614. If permission was granted, the program continues in block 606, where the member's profile is retrieved from Social Network 50, and then in block 608, the profile that was retrieved is scanned for keywords and events of interest. The scanning is done using data mining techniques. Then in block 610 any keywords that were retrieved are stored in the member's profile in Application Database 54. Then in block 612, any events that were found are added to the events (greeting opportunities) associated with the member in Application Database 54.

The above specification describes a new and improved method for utilizing social networks to promote goods and services and using relevant data for direct marketing campaigns. It is realized that the above description may indicate to those skilled in the art additional ways in which the principles of this invention may be used without departing from the spirit. Therefore, it is intended that this invention be limited only by the scope of the appended claims.

What is claimed is:

1. A method for customizing direct marketing campaigns, the method comprises the steps of:
utilizing relationships within a computer social network and information that is known about the social network members to find the best opportunity to provide an offer for goods and services to potential customers;
providing offers for the goods and the services via the computer based upon receiving recommendations from acquaintances of potential customers via the social networks; and
sending offers to the potential customers via the computer on behalf of their acquaintance.

2. The method claimed in claim 1, further includes the step of: accepting by the potential customer the offer.

3. The method claimed in claim 1, further includes the step of: including a gift in the offer.

4. The method claimed in claim 1, further includes the step of: providing a greeting card with the offer.

5. The method claimed in claim 1, further includes the step of: having the offer attached to a greeting card.

6. The method claimed in claim 1, wherein if the potential customer decides to act on the offer, the potential customer will bring the offer to a sponsoring vendor or store of the offer.

7. The method claimed in claim 6, further including the step of: affixing a unique encrypted number to the offer.

8. The method claimed in claim 7, further including the step of: verifying by the sponsoring vendor the unique encrypted number to honor the offer and complete a sale of selected goods and/or services.

9. The method claimed in claim 1, further including the step of: tracking the offers to permit a sponsoring vendor to determine the success rate of specific offers.

10. The method claimed in claim 1, further including the step of: having the offer attached to a post card.

11. The method claimed in claim 1, further including the step of: having the offer included in an envelope.

12. The method claimed in claim 1, wherein a vendor specifies rules for distributing the offer.

13. The method claimed in claim 1, further including the step of: limiting numbers of the offer that are produced for the potential customer so that the potential customer will only receive a specified number of the offer for the goods and/or services.

14. The method claimed in claim 1, wherein the offer to the potent ional customer for the goods and/or services are selected by a response rate for a vendor.

15. The method claimed in claim 1, wherein the offer to the potent ional customer for the goods and/or services are selected by a response rate for type of the goods and/or services offered for sale.

16. The method claimed in claim 1, wherein the offer to the potent ional I customer for the goods and/or services are selected by a response rate for type of potent ional customer.

18. The method claimed in claim 1, wherein the offer to the potent ional customer for the goods and/or services are selected by a response rate for type of the potent ional customer.

19. The method claimed in claim 1, wherein the offer to the potent ional customer for the goods and/or services are selected by a response rate for a location of where the goods and/or services are delivered.

20. The method claimed in claim 1, wherein the offer to the potent ional customer for the goods and/or services are selected by a response rate based upon relationship between the member and the potent ional customer.

21. The method claimed in claim 1, wherein the offer to the potent ional customer for the goods and/or services are selected by a response rate for the social network member.
